(19) United States
(12) Patent Application Publication
(10) Pub. No.: US 2024/0394938 A1
(43) Pub. Date: Nov. 28, 2024

(54) IMAGE PROCESSING METHOD, APPARATUS, ELECTRONIC DEVICE, AND STORAGE MEDIUM

(71) Applicant: Beijing Zitiao Network Technology Co., Ltd., Beijing (CN)

(72) Inventors: Zehua BAO, Beijing (CN); Weifeng LIN, Beijing (CN)

(21) Appl. No.: 18/674,408

(22) Filed: May 24, 2024

(30) Foreign Application Priority Data
May 25, 2023 (CN) 202310603427.X

(51) Int. Cl. G06T 11/20; G06T 3/40; G06T 5/50; G06T 7/13

(52) U.S. Cl. CPC G06T 11/203; G06T 3/40; G06T 5/50; G06T 7/13; G06T 2207/20221

(57) ABSTRACT

The present disclosure provides an image processing method, an image processing apparatus, an electronic device, and a storage medium. The method includes: acquiring a first image drawn for a drawing object, determining, according to a target magnification, a pixel area block to which the first pixel is mapped in a second image, determining target pixel values of second pixels in the pixel area block, and obtaining the second image after magnification according to the target pixel values of the second pixels in the pixel area block; and generating, according to the second image, a material object to which the drawing object corresponds, and mounting the material object to a corresponding position of a target object.

### CROSS-REFERENCE TO RELATED APPLICATION

This application claims priority to Chinese Patent Application No. 202310603427.X, filed on May 25, 2023, the entire disclosure of which is incorporated herein by reference as part of the present disclosure.

### TECHNICAL FIELD

The present disclosure relates to the field of computer technology, in particular, to an image processing method, an image processing apparatus, an electronic device, and a storage medium.

### BACKGROUND

Currently, effect functions are provided in some short video applications; for example, wearing effects are added to characters in a try-on scenario in short videos. However, in the related art, only fixed effect templates are provided in short video applications, and user-defined editing is not supported, reducing flexibility of use and personalized needs.

### SUMMARY

Embodiments of the present disclosure at least provide an image processing method, an image processing apparatus, an electronic device, and a storage medium.

At least an embodiment of the present disclosure provides an image processing method, comprising: acquiring a first image drawn for a drawing object, wherein the drawing object is correspondingly split into a plurality of sub-objects, the first image is acquired by merging the plurality of sub-objects respectively drawn on a plurality of sub-canvases, and each of the plurality of sub-canvases is used for drawing one corresponding sub-object; determining, for a first pixel in the first image, according to a target magnification, a pixel area block to which the first pixel is mapped in a second image, determining target pixel values of second pixels in the pixel area block, and obtaining the second image after magnification according to the target pixel values of the second pixels in the pixel area block; and generating, according to the second image, a material object to which the drawing object corresponds, and mounting the material object to a corresponding position of a target object.

For example, the image processing method further comprises: presenting the plurality of sub-canvases in response to a drawing object template selected for the drawing object, the plurality of sub-canvases corresponding to the drawing object template; determining a sub-canvas currently operated in response to a switching operation for the plurality of the sub-canvases, receiving a drawing operation on the sub-canvas currently operated, and obtaining a target pattern drawn on the sub-canvas currently operated.

For example, the determining, for a first pixel in the first image, according to a target magnification, a pixel area block to which the first pixel is mapped in a second image, and determining target pixel values of second pixels in the pixel area block, comprises: acquiring, for the first pixel in the first image, peripheral pixels within a corresponding adjacent target range of the first pixel; determining, respectively for each target direction of the first pixel, whether an edge pixel exists in the each target direction in the first image for the first pixel according to pixel values of the peripheral pixels, and determining an initial pixel value of a second pixel corresponding to each target direction in the pixel area block according to a determination result of whether the edge pixel exists, until it is completed in all target directions, and determining the target pixel value of each of the second pixels in the pixel area block according to initial pixel values of each second pixel corresponding to all target directions, wherein the target direction is related to a distribution position of the second pixels in the pixel area block.

For example, the determining an initial pixel value of a second pixel corresponding to each target direction in the pixel area block according to a determination result of whether the edge pixel exists, comprises: for each target direction, in response to an edge pixel in the target direction existing, determining a corresponding second pixel to the target direction in the pixel area block, determining an interpolated pixel value of the corresponding second pixel, and determining an initial pixel value of the corresponding second pixel according to a pixel value of the first pixel and the interpolated pixel value; and in response to an edge pixel in the target direction not existing, determining an initial pixel value of a corresponding second pixel to the target direction in the pixel area block according to the pixel value of the first pixel.

For example, the determining an interpolated pixel value of the corresponding second pixel comprises: screening out first peripheral pixels associated with the target direction from the peripheral pixels; determining a pixel distance between the first pixel and each of the first peripheral pixels respectively, wherein the pixel distance represents a distance between a central point of the first pixel and a central point of each first peripheral pixel; and determining the interpolated pixel value of the corresponding second pixel according to a pixel value of a first peripheral pixel which has the smallest pixel distance to the first pixel.

For example, the determining an initial pixel value of the corresponding second pixel according to a pixel value of the first pixel and the interpolated pixel value comprises: determining a second peripheral pixel corresponding to each of the first peripheral pixels in a direction of a designated angle in the first image, wherein central points of each first peripheral pixel and the corresponding second peripheral pixel are connected by a straight line passing through the first pixel, to form the direction of the designated angle; judging whether pixel values of the first peripheral pixel and the corresponding second peripheral pixel are same; in response to the pixel values being the same corresponding to the direction of the designated angle, determining a corresponding second pixel in the pixel area block to the direction of the designated angle and determining the initial pixel value of the corresponding second pixel according to the pixel value of the first pixel, the interpolated pixel value, and the designated angle; in response to the pixel values being different in each direction of the designated angle, determining the initial pixel value of the corresponding second pixel according to an average value of the pixel value of the first pixel and the interpolated pixel value.

For example, the determining the initial pixel value of the corresponding second pixel according to the pixel value of the first pixel, the interpolated pixel value, and the designated angle, comprises: determining the initial pixel value of the corresponding second pixel to be a weighted average value of the pixel value of the first pixel and the interpolated pixel value, wherein weights of the pixel value of the first pixel and the interpolated pixel value are determined by the designated angle.

For example, the determining the initial pixel value of the corresponding second pixel according to an average value of the pixel value of the first pixel and the interpolated pixel value comprises: determining the initial pixel value of the corresponding second pixel to be the average value of the pixel value of the first pixel and the interpolated pixel value.

For example, the determining the target pixel value of each of the second pixels in the pixel area block according to initial pixel values of each second pixel corresponding to all target directions, comprises: for each of the second pixels, determining the initial pixel values of each second pixel corresponding to all target directions from the determined initial pixel values of second pixels corresponding to all target directions, and weighted averaging the determined initial pixel values of each second pixel corresponding to all target directions, and obtaining the target pixel value of each second pixel in the pixel area block.

For example, the determining the initial pixel value of the corresponding second pixel according to a pixel value of the first pixel and the interpolated pixel value comprises: screening out first peripheral pixels associated with the target direction from the peripheral pixels; determining a second peripheral pixel corresponding to each first peripheral pixel in a direction of a designated angle in the first image, wherein central points of each first peripheral pixel and the second peripheral pixel are connected by a straight line passing through the first pixel, to form the direction of the designated angle; judging whether pixel values of the first peripheral pixel and the corresponding second peripheral pixel are same; in response to the pixel values being the same corresponding to the direction of the designated angle, determining a corresponding second pixel in the pixel area block to the direction of the designated angle and determining the initial pixel value of the corresponding second pixel according to the pixel value of the first pixel, the interpolated pixel value, and the designated angle; in response to the pixel values being different in each direction of the designated angle, determining the initial pixel value of the corresponding second pixel according to an average value of the pixel value of the first pixel and the interpolated pixel value.

For example, the determining the initial pixel value of the corresponding second pixel according to the pixel value of the first pixel, the interpolated pixel value, and the designated angle, comprises: determining the initial pixel value of the corresponding second pixel to be a weighted average value of the pixel value of the first pixel and the interpolated pixel value, wherein weights of the pixel value of the first pixel and the interpolated pixel value are determined by the designated angle.

For example, the determining the initial pixel value of the corresponding second pixel according to an average value of the pixel value of the first pixel and the interpolated pixel value comprises: determining the initial pixel value of the corresponding second pixel to be the average value of the pixel value of the first pixel and the interpolated pixel value.

For example, the determining an initial pixel value of a corresponding second pixel to the target direction in the pixel area block according to the pixel value of the first pixel comprises: determining the pixel value of the first pixel to be the initial pixel value of the corresponding second pixel.

For example, the determining the target pixel value of each of the second pixels in the pixel area block according to initial pixel values of each second pixel corresponding to all target directions, comprises: weighted averaging the initial pixel values of each of the second pixels corresponding to each target direction, and obtaining the target pixel value of each second pixel in the pixel area block.

At least an embodiment of the present disclosure provides an image processing apparatus comprising: an obtaining module, configured to obtain a first image drawn for a drawing object, wherein the drawing object is correspondingly split into a plurality of sub-objects, the first image is acquired by merging the plurality of sub-objects respectively drawn on a plurality of sub-canvases, and each of the plurality of sub-canvases is used for drawing one corresponding sub-object; an image processing module, configured to determine, for a first pixel in the first image, according to a target magnification, a pixel area block to which the first pixel is mapped in a second image, determining target pixel values of second pixels in the pixel area block, and obtaining the second image after magnification according to the target pixel values of the second pixels in the pixel area block; and a mounting module configured to generate, according to the second image, a material object to which the drawing object corresponds, and mounting the material object to a corresponding position of a target object.

At least an embodiment of the present disclosure provides an electronic device, comprising a processor and a memory storing machine-readable instructions executable by the processor, wherein the processor is configured to execute the machine-readable instructions stored in the memory; when the machine-readable instructions are executed by the processor, the image processing method according to any one of the above embodiments is implemented by the processor.

At least an embodiment of the present disclosure provides a non-transitory computer-readable storage medium storing a computer program, wherein when the computer program is executed by the processor, the image processing method according to any one of the above embodiments is implemented.

### BRIEF DESCRIPTION OF DRAWINGS

The accompanying drawings, which are hereby incorporated in and constitute a part of the present description, illustrate embodiments of the present disclosure, and together with the description, serve to explain the principles of the embodiments of the present disclosure. To describe the technical solutions in the embodiments of the present disclosure or in the prior art more clearly, the accompanying drawings required in the description of the embodiments or the prior art will be described briefly below. Apparently, other accompanying drawings can also be derived from these drawings by those ordinarily skilled in the art without creative efforts.

FIG. 1 shows a flowchart of an image processing method according to an embodiment of the present disclosure;

FIG. 2 is a schematic diagram illustrating an effect of merging multiple sub-canvases according to an embodiment of the present disclosure;

FIG. 3 shows a schematic diagram of acquired peripheral pixels provided by an embodiment of the present disclosure;

FIG. 4 shows an effect schematic diagram of target directions of a first pixel provided by an embodiment of the present disclosure;

FIG. 5 shows a principle schematic diagram of determining whether an edge pixel in a target direction exists provided by an embodiment of the present disclosure;

FIG. 6 shows a principle schematic diagram of interpolation of a second pixel provided by an embodiment of the present disclosure;

FIG. 7 shows another principle schematic diagram of interpolation of second pixels provided by an embodiment of the present disclosure;

FIG. 8 shows still another principle schematic diagram of interpolation of second pixels provided by an embodiment of the present disclosure;

FIG. 9 shows a flowchart of another image processing method provided by an embodiment of the present disclosure;

FIG. 10 shows a schematic diagram of an image processing apparatus according to an embodiment of the present disclosure; and

FIG. 11 shows a schematic diagram of an electronic device according to an embodiment of the present disclosure.

### DETAILED DESCRIPTION

It can be understood that before using the technical solution disclosed by the embodiments of the present disclosure, the type, the use range, the use scenario, and the like of the personal information to which the present disclosure relates should be informed to the user and be authorized by the user in an appropriate manner in accordance with the relevant laws and regulations.

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Usually, the components of the embodiments of the present disclosure as described and illustrated herein could be arranged and designed in a wide variety of different configurations. Thus, the following detailed description of the embodiments of the disclosure is not intended to limit the protection scope of the disclosure, but is merely representative of optional embodiments of the disclosure. Based on the embodiments of the present disclosure, all other embodiments obtained by those skilled in the art without making creative labor belong to the scope of protection of the present disclosure.

To facilitate the understanding of the technical solutions of the present disclosure, technical terms in the embodiments of the present disclosure are first explained as follows.

Map: a map may be understood as an attribute parameter in a shader that is responsible for combining input vertex data in a specified way with the input map or color, etc., and then providing outputs, according to which a drawing unit can then draw an image onto a screen.

Material: the input map or color, etc., plus the corresponding shader, and the specific parameter settings of the shader, are packaged and stored together to obtain a material. Other parameters may be included in the packaged package. The material can then be assigned to a 3D model for drawing and output. For ease of understanding, it may be considered that the material is the product which an engine ultimately uses, the shader is the process for producing the product, and the map is the raw material for the product.

It is found that effect functions are provided in some short video applications; for example, wearing effects are added to characters in a try-on scenario in short videos. However, in the related art, only fixed effect templates are provided in short video applications, and user-defined editing is not supported, reducing flexibility of use and personalized needs.

Based on the above studies, the present disclosure provides an image processing method, implementing a brush canvas system, supporting multiple types of brushes, multiple canvases, multiple kinds of drawing objects, etc., which can draw on multiple sub-canvases of the drawing object, and thereby merge to obtain a first image of the drawing object, and thereby determine, for a first pixel in the first image, according to a target magnification, a pixel area block to which the first pixel is mapped in a second image, and determine a target pixel value of a second pixel in the pixel area block, obtain an enlarged second image according to the target pixel value of the second pixel in the pixel area block, obtain, according to the second image, a material object corresponding to the drawing object, and mount the material object to a corresponding position of the target object. In this way, the function that users can customize drawing objects is realized, and the personalized requirements are met. Moreover, the drawn first image can be enlarged to regenerate the material object, so that a canvas with a lower resolution can be used for drawing, pixels needed to be drawn by the user are reduced, the cost is reduced, and the efficiency is improved. The first image is then enlarged to obtain the image with an higher resolution, thereby ensuring final definition and image quality, and improving presentation effect.

The deficiencies of the above solutions are all the results of the inventor's practice and careful study, and therefore, the discovery process of the above problems and the solutions proposed by the present disclosure to the above problems hereinafter should be contributions made by the inventor(s) to the present disclosure.

It should be noted that like numerals and letters represent like items in the following figures, and therefore, once an item is defined in one figure, it is not needed to be further defined and explained in the following figures.

In order to facilitate the understanding of the present embodiment, first, a detailed description will be made of an image processing method disclosed by an embodiment of the present disclosure. The executive body of the image processing method provided by an embodiment of the present disclosure is generally an electronic device having a certain computing capability; the electronic device includes, for example, a terminal device or a server or other processing device, and the terminal device may be a user equipment (UE), a mobile device, a cellular phone, a cordless phone, a personal digital assistant (PDA), a handheld device, a computing device, a vehicle-mounted device, a wearable device, and the like; the personal digital assistant is a handheld electronic device having some functions of an electronic computer and may be used to manage personal information, to browse through the Internet, to send and receive e-mail, etc., and is generally not equipped with a keyboard, and may also be referred to as a palm top computer. In some possible implementations, the image processing method may be implemented through invoking computer readable instructions stored in a memory by a processor.

The image processing method provided by the embodiment of the present disclosure is explained below taking the executive body as the terminal device as an example.

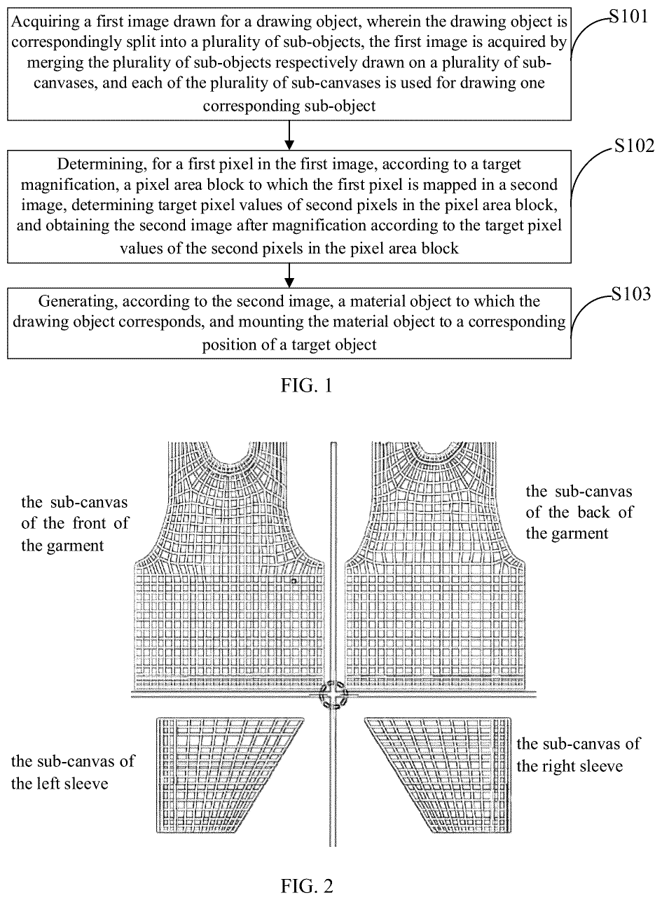

Referring to FIG. 1, a flow chart of an image processing method provided for an embodiment of the present disclosure, the method comprises following steps S101-S103.

S101: acquiring a first image drawn for a drawing object, wherein the drawing object is correspondingly split into a plurality of sub-objects, the first image is acquired by merging the plurality of sub-objects respectively drawn on a plurality of sub-canvases, and each of the plurality of sub-canvases is used for drawing one corresponding sub-object.

The embodiments of the present disclosure are mainly directed to the effects field, for example, try-on effects in short video. The user can adopt effects to increase interestingness and personalization when shooting short videos; however, in the related art, it is common to provide some fixed effects, and the user cannot perform user-defined editing. In the embodiment of the present disclosure, the user drawing function can be implemented in the terminal apparatus, which can be applied to a wearing-like scene or other effects scene without limitation.

Accordingly, in an embodiment of the present disclosure, a paintbrush canvas system is provided that supports multi-type paintbrushes, multi-canvases, a variety of drawing objects, and the like, specifically providing a possible implementation which comprises presenting the plurality of sub-canvases in response to a drawing object template selected for the drawing object, the plurality of sub-canvases corresponding to the drawing object template, and determining a sub-canvas currently operated in response to a switching operation for the plurality of the sub-canvases, receiving a drawing operation on the sub-canvas currently operated, and obtaining a target pattern drawn on the sub-canvas currently operated.

That is, in an embodiment of the present disclosure, a multi-canvas function is provided, a plurality of sub-objects can be split for different drawing objects, one sub-object corresponds to one sub-canvas, i.e., one sub-object corresponding to each sub-canvas can be drawn on the each sub-canvas, and the count of the sub-canvases is the same as the count of the sub-objects that the drawing object is split into. For example, the drawing object is a garment which can be split into two sleeves and the front and back of the garment, that is four sub-objects corresponding to four sub-canvases, each sub-canvas can be drawn separately, the user can select different drawing object templates to present corresponding sub-canvases, and thereby can customize the drawing on the sub-canvases. Of course, the count of sub-canvases for different painting objects may be set and is not limited in the disclosed embodiment. For example, the drawing object is a mask and only one canvas may be required, and multiple sub-canvases may be merged into a larger canvas at predetermined frame intervals during the drawing process, e.g., per frame, so that the overall effect of the drawing object may be displayed in real time.

The size of the first image or sub-canvas may also be set. In one possible implementation, the size of the first image is a predetermined first size, the size of the plurality of sub-canvases is related to the first size, and the size of the first image is the size of the merged canvas. For example, a garment may have four sub-canvases corresponding to the first size, then four sub-canvases and one merged canvas may need to be created while drawing the garment. Referring to FIG. 2, a diagram illustrating the effect of merging a plurality of sub-canvases according to an embodiment of the present disclosure, the size of the final merged canvas of the garment may be set to be 64*64 pixels, the size of the sub-canvas of the front of the garment may be 32*40 pixels, the size of the sub-canvas of the back of the garment may be 32*40 pixels, the size of the sub-canvas of the left sleeve may be 32*24 pixels, and the size of the sub-canvas of the right sleeve is 32*24 pixels, as shown in FIG. 2, and the size of the merged canvas is 64*64 pixels.

In addition, embodiments of the present disclosure provide a paintbrush system supporting multiple types of paintbrushes, such as paintbrushes for drawing lines, circles, hearts, squares, and the like, and also palettes of different colors. The user can draw target patterns of different colors and different types of on each sub-canvas according to the needs, and embodiments of the present disclosure can support touch drawing by the user during drawing, such as receiving a touch track on the sub-canvases to determine the corresponding target pattern. Further, in order to improve the drawing accuracy, embodiments of the present disclosure provide a possible implementation for monitoring touch information, acquiring touch point positions, and mapping the touch point position to the corresponding position of the sub-canvas, which in turn can be transferred to the shader so that the shader can accurately draw on the pixel of the corresponding position of the sub-canvas according to the corresponding mapped position. The sub-canvas can be set to a smaller size, i.e., resolution, to improve efficiency and reduce the cost of drawing. The sub-canvas can be understood as a map of M*N small squares with a lower resolution, and the resolution of the touch screen information is generally higher, so the touch screen information can be mapped from a high resolution to a low resolution by mapping the touch point position of the screen to the sub-canvas position, therefore ensuring that the coordinates of the position of the touch screen point corresponding to a certain square in the sub-canvas are consistent, improving accuracy.

S102: determining, for a first pixel in the first image, according to a target magnification, a pixel area block to which the first pixel is mapped in a second image, determining target pixel values of second pixels in the pixel area block, and obtaining the second image after magnification according to the target pixel values of the second pixels in the pixel area block.

In an embodiment of the present disclosure, a first image including a target pattern drawn in each sub-canvas can be obtained by merging a plurality of sub-canvases. Further, in the embodiment of the present disclosure, in order to reduce the user's drawing cost and allow the user to obtain a relatively good drawing effect, a low-resolution sub-canvas can be set while drawing, and the count of pixels that the user needs to draw is less. Then, after the drawing is completed, the merged first image is post-processed and converted into a high-resolution second image by enlarging, thereby achieving a low-cost drawing function in the terminal device.

In embodiments of the present disclosure, the target magnification can be preset, or can be determined according to the preset size of the second image and the first image. In one embodiment, the target magnification is a positive integer multiple of 2. For example, in the case that the size of the first image is 64*64 and the size of the second image is 128*128, the target magnification is 2. If each pixel in the image is treated as a small square, then each pixel in the first image is mapped to four new pixels in the second image, and the four new pixels may be treated as a pixel area block. Therefore, in the embodiment of the present disclosure, for each first pixel in the first image, the value of the new second pixel in the pixel area block mapped to the second image can be determined, so the enlarged second image can be obtained.

S103: generating, according to the second image, a material object to which the drawing object corresponds, and mounting the material object to a corresponding position of a target object.

In an embodiment of the present disclosure, the enlarged second image may be imparted as a sticker to a certain material to generate a material object which may obtain a more realistic effect in an actual application scenario, and then may be mounted more accurately and snugly to a corresponding position of a target object by a recognition algorithm or the like, without limitation; for example, the drawing object may be a hat, the target object may be a person, and the cap may be mounted to the head of the person as a effect after the process.

In an embodiment of the present disclosure, a first image of the drawn object is obtained after merging according to the sub-objects respectively drawn on the plurality of sub-canvases; further a pixel area block to which the first pixel is mapped is determined in a second image and a target pixel value of a second pixel in the pixel area block is determined according to a target magnification for the first pixel in the first image, and a magnified second image is obtained according to the target pixel value of the second pixel in the pixel area block; a material object corresponding to the drawing object is generated according to the second image, and the material object is mounted to the corresponding position of the target object. Therefore, the user can customize the drawing object to meet the user's personalization requirement; a low-resolution first image can be set to reduce the drawing cost and improve the efficiency, and then the low-resolution first image can be converted into a high-resolution second image through a magnification process, thereby not only achieving a more efficient drawing function, but also guaranteeing the final image quality and avoiding blurring of the image presentation.

In addition, in the embodiment of the present disclosure, when performing the magnification process on the first image, not only the magnification process is performed, but also the second image after the magnification is guaranteed not to be blurred, so for the determining, for a first pixel in the first image, according to a target magnification, a pixel area block to which the first pixel is mapped in a second image, determining target pixel values of second pixels in the pixel area block, and obtaining the second image after magnification according to the target pixel values of the second pixels in the pixel area block in the above step S102, possible implementation is also provided, and specifically, including following steps S1-S2.

S1. acquiring, for the first pixel in the first image, peripheral pixels within a corresponding adjacent target range of the first pixel.

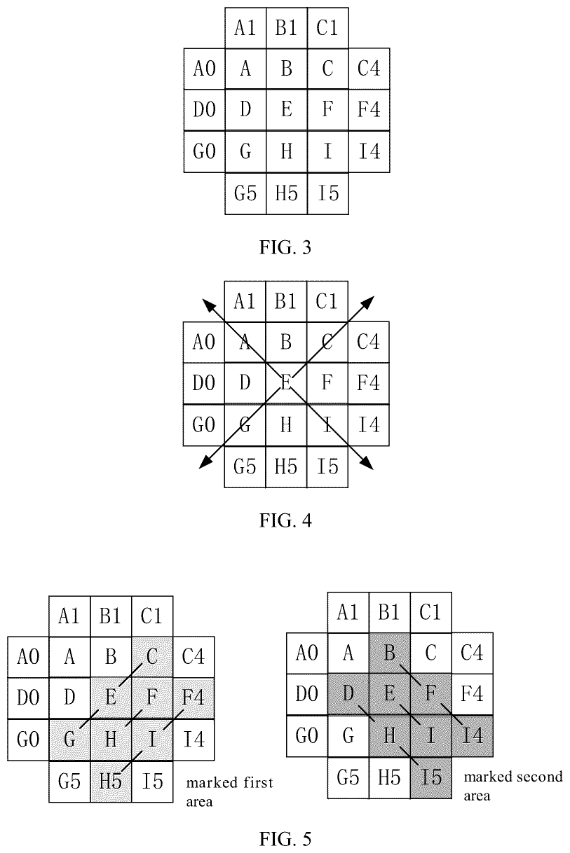

A plurality of peripheral pixels are acquired, the acquisition of the peripheral pixels is related to the target magnification, and the target magnification is related to the number of second pixels in the corresponding pixel area block, or it can be understood that the acquisition of the peripheral pixels is related to the corresponding pixel area block. In one possible embodiment, a first pixel is centered in the first image, and the greatest step size of the first pixel to a peripheral pixel is the target magnification number of squares, for example, the size of the first image is 8*8, the size of the second image is 16*16, and the target magnification is 2, and one first pixel corresponds to the enlarged pixel area block including four second pixels, as shown in FIG. 3, a schematic diagram of the peripheral pixels acquired in the embodiment of the present disclosure, taking the first pixel E currently processed in the first image as an example. The peripheral pixels within a corresponding range of the pixel E in the first image are acquired, that is, the respective pixels as shown in FIG. 3, which are marked in FIG. 3, such as A1, B1, and the like, only to facilitate distinction and description of the respective pixels, and not to limit implementation of the present disclosure.

S2, determining, respectively for each target direction of the first pixel, whether an edge pixel exists in the each target direction in the first image for the first pixel according to pixel values of the peripheral pixels, and determining an initial pixel value of a second pixel corresponding to each target direction in the pixel area block according to a determination result of whether the edge pixel exists, until it is completed in all target directions, and determining the target pixel value of each of the second pixels in the pixel area block according to initial pixel values of each second pixel corresponding to all target directions, wherein the target direction is related to a distribution position of the second pixels in the pixel area block.

In the embodiment of the present disclosure, for example, the target magnification is 2, four second pixels are in the pixel area block corresponding to one first pixel, and the values of the four second pixels corresponding to the first pixel need to be determined when generating the magnified second image. In order to reduce the blur of the magnified image, edge detection, interpolation, etc. are performed to obtain a smoother second image, instead of directly copying the values of the first pixel as the values of the corresponding four second pixels. Specifically, in the embodiment of the present disclosure, the pixel value each of the second pixels in the pixel area block may be respectively calculated and the second pixels may be corresponding to different directions with respect to the corresponding first pixel. For example, referring to FIG. 4, which is a diagram showing the effect of the target direction of the first pixel in the embodiment of the present disclosure, the first pixel E corresponds to four second pixels, and each second pixel E corresponds to one target direction; as shown by arrows in FIG. 4, the first pixel E corresponds to four target directions.

The effect of determining the target direction is to determine whether each target direction is at an edge or not for edge detection, to obtain the target pixel value of the second pixel with more accurate and smooth processing.

The following is specifically introduced taking any one target direction of any one of the first pixels as an example.

For determining the initial pixel value of the corresponding second pixel in the target direction in the pixel area block in the above step S2 according to the determination result of whether there is an edge pixel, the embodiment of the present disclosure provides a possible implementation, which can be specifically divided into the following cases.

In the case there is no edge pixel in the target direction, an initial pixel value of a corresponding second pixel in the target direction in the pixel area block is determined according to the pixel value of the first pixel.

That is, in the embodiment of the present disclosure, if the first pixel does not have an edge pixel in the target direction, it is considered that the first pixel is not in an edge position, and the first pixel has the same color, i.e., the same pixel value, as the immediately adjacent first pixel in the target direction, and the pixel value of the first pixel is directly assigned to the corresponding second pixel in the target direction, without introducing abrupt change in color between the second pixel and the other second pixel adjacent to the second pixel after enlargement.

In addition, the edge pixel represents discontinuous distribution of characteristics (e.g., pixel gradations, textures, etc.) which change significantly in the image, and it can be determined by an edge detection method for determining whether there is an edge pixel in the target direction of the first pixel, without limitation. For example, taking the target direction at the lower right in FIG. 4 as an example, that is, it is necessary to determine whether there is an edge in the H-F direction of the first pixel E, and in order to determine whether there is an edge in the H-F direction, it can be calculated whether or not the H-F direction is an edge with respect to an adjacent row.

Referring to FIG. 5, which is a schematic diagram of determining whether there is an edge pixel in a target direction provided in an embodiment of the present disclosure, the weighted distance sum of the first area and the second area marked in gray in FIG. 5 may be calculated, respectively, and the weighted distance sums of the first area and the second area may be compared, in order to calculate whether there is an edge in the H-F direction. Specifically, as shown in FIG. 5, the first weighted distance sum corresponding to the first area is denoted by wdl, wdl=d (E, C)+d (E, G)+d (I, F4)+d (I, H5)+4*d (H, F), the second weighted distance sum corresponding to the second area is denoted by wd2, wd2=d (H, d)+d (H, I5)+d (F, I4)+d (F, B)+4*d (E, I), and wdl and wd2 may be compared. If wdl is less than wd2, I.E., that is, the weighted distance sum corresponding to the first area is less, it may be concluded that the edge is along the H-F direction, and it is determined that there is an edge pixel in the target direction. If wdl is not less than wd2, it may be determined that there is no edge pixel in the corresponding target direction.

d ( ) is a function for calculating a distance and for calculating the distance between pixels in RGB or YCbCr color space, and since RGB color space does not actually comply with user's needs for perceiving colors and RGB color space is not uniform, it is preferable to convert to YCbCr color space for distance calculation in order to accurately obtain color distances.

In the case that there is an edge pixel in the target direction, a corresponding second pixel to the target direction in the pixel area block is determined, an interpolated pixel value of the corresponding second pixel is determined, and an initial pixel value of the corresponding second pixel according to a pixel value of the first pixel and the interpolated pixel value is determined, which includes following steps 1-2.
Step 1: determining an interpolated pixel value of a corresponding second pixel, comprising following steps 1)-5).
Step 1): screening out first peripheral pixels associated with the target direction from the peripheral pixels.

For example, taking the target direction at the bottom right in FIG. 4 as an example, the first peripheral pixels associated with the target direction are identified as H and F.
Step 2): determining a pixel distance between the first pixel and each of the first peripheral pixels respectively, wherein the pixel distance represents a distance between a central point of the first pixel and a central point of each first peripheral pixel.
Step 3): determining the interpolated pixel value of the corresponding second pixel according to a pixel value of a first peripheral pixel which has the smallest pixel distance to the first pixel.

For example, if the pixel distance between the first pixel E and the first peripheral pixel F is less than or equal to the pixel distance between the first pixel E and the first peripheral pixel H, the interpolated pixel value is determined to be a pixel value of F, otherwise, the interpolated pixel value is determined to be a pixel value of H.
Step 2: determining the initial pixel value of the corresponding second pixel according to the pixel value of the first pixel and the interpolated pixel value, comprising following steps 1)-4).
Step 1): screening out first peripheral pixels associated with the target direction from the peripheral pixels.
Step 2) determining a second peripheral pixel corresponding to each first peripheral pixel in a direction of a designated angle in the first image, wherein central points of each first peripheral pixel and the second peripheral pixel are connected by a straight line passing through the first pixel, to form the direction of the designated angle.

For example, taking the target direction at the lower right in FIG. 4 as an example, while calculating the pixel value of the second pixel in the lower right direction in the pixel area block to which the first pixel corresponds, in order to more fully take into account the color influence of the first peripheral pixels, it is also possible in the embodiment of the present disclosure to synthetically determine a plurality of specified angular directions. Taking the first peripheral pixels H and F as an example, the detections of the specified angles are 25-degree and 75-degree directions centered on the pixel E, associated with H and F, and the second peripheral pixel corresponding to H is C, and the second peripheral pixel corresponding to F is G.
Step 3): judging whether the pixel values of the first peripheral pixel and the corresponding second peripheral pixel are the same.

For example, it is judged whether or not the pixel values of H and C are the same, and it is judged whether or not the pixel values of F and G are the same, and the pixel values of the colors may be represented by floating point numbers, with a certain error, so a certain threshold range is allowed in judging whether or not the same, i.e., the pixel values that differ within the certain threshold range can also be determined to be the same.
Step 4): in response to the pixel values being the same corresponding to a direction of a designated angle, determining a corresponding second pixel in the pixel area block to the direction of the designated angle and determining the initial pixel value of the corresponding second pixel according to the pixel value of the first pixel, the interpolated pixel value, and the designated angle.

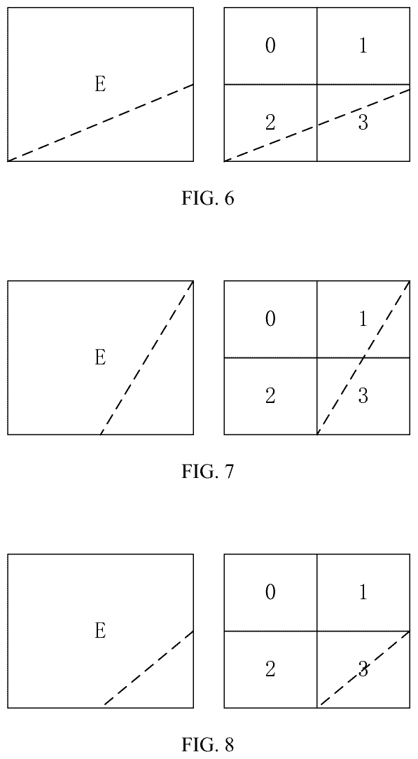

For example, referring to FIG. 6, which is a schematic diagram illustrating the interpolation of the second pixel according to the embodiment of the present disclosure, taking an example of a target magnification of 2 times, the enlarged pixel area block corresponding to the first pixel E includes four second pixels which are denoted by 0, 1, 2, and 3. Taking the bottom right direction as an example, while calculating the initial pixel value of the second pixel 3, if the pixel value of the pixels G and F are determined to be the same, the interpolation process is performed as shown in the right of FIG. 6, and the area below the dashed line of FIG. 6 is affected by the interpolated pixel value. It is understood that the second pixel 3 is affected by 75% and the second pixel 2 is affected by 25%, and it is determined the initial pixel value of the second pixel 3=25%*pixel value of E+75%*interpolated pixel value, the initial pixel value of the second pixel 2=75*pixel value of E+25%*interpolated pixel value.

For another example, referring to FIG. 7, which is another principle diagram of the interpolation of the second pixel according to the embodiment of the present disclosure, if the pixel values of H and C are the same, the interpolation process as shown in the right of FIG. 7 is performed, in which case the second pixel 3 is affected by 75% and the second pixel 1 is affected by 25%, it is determined that the initial pixel value of the second pixel 3=25%*pixel value of E+75%*interpolated pixel value, and the initial pixel value of the second pixel 1=75*pixel value of E+25%*interpolated pixel value.

Of course, if it is judged that the pixel values of H and C are the same, while the pixel values of F and G are the same, the calculation based on the interpolation processing shown in both FIGS. 6 and 7 is required.
Step 5): in response to the pixel values being different in each direction of the designated angle, determining the initial pixel value of the corresponding second pixel according to an average value of the pixel value of the first pixel and the interpolated pixel value.

For example, referring to FIG. 8, which is another principle diagram of the interpolation of the second pixel in the embodiment of the present disclosure, when it is judged that the pixel values of H and C are not the same, and the pixel values of F and G are not the same, then the interpolation process as shown in the right of FIG. 8 is performed, and the second pixel 3 is affected by 50%, then it is determined that the initial pixel value of the second pixel 3=50%*pixel value of E+50%*interpolated pixel value.

It should be noted that it is processed in the other target directions of the first pixel in a similar manner as the above implementation of the lower right target direction in the embodiment of the present disclosure, and will not be described in detail herein, and further, for any one first pixel, after it is processed in each target direction of the first pixel, the target pixel values of the second pixels in the pixel area block mapped by the first pixel can be finally determined, and for the above step S2 of determining the target pixel value of each of the second pixels in the pixel area block according to initial pixel values of each second pixel corresponding to all target directions, the embodiment of the present disclosure provides a possible implementation, comprising: weighted averaging the initial pixel values of each of the second pixels corresponding to each target direction, and obtaining the target pixel value of each second pixel in the pixel area block.

For example, the initial pixel values of the second pixels 2 and 3 are determined while processing in the lower right direction of the first pixel E, and the initial pixel value of the second pixel 2 is determined while processing in the lower left target direction, and the initial pixel value of the second pixel 2 is not obtained in the other target directions, so the target pixel value of the second pixel 2 is finally obtained as a weighted average of the initial pixel values obtained in the lower-right target direction and the lower-left target direction, which is not limited in the embodiment of the present disclosure.

In this way, in the embodiment of the present disclosure, the initial pixel value of the second pixel in the pixel area block mapped by the first pixel is determined, and the target pixel value of the second pixel is finally determined through edge detection and interpolation processing, and then the magnified second image can be generated according to the target pixel value of the second pixel. Therefore, the magnified second image can be guaranteed not to be blurred, and the image resolution and the image quality can be improved.

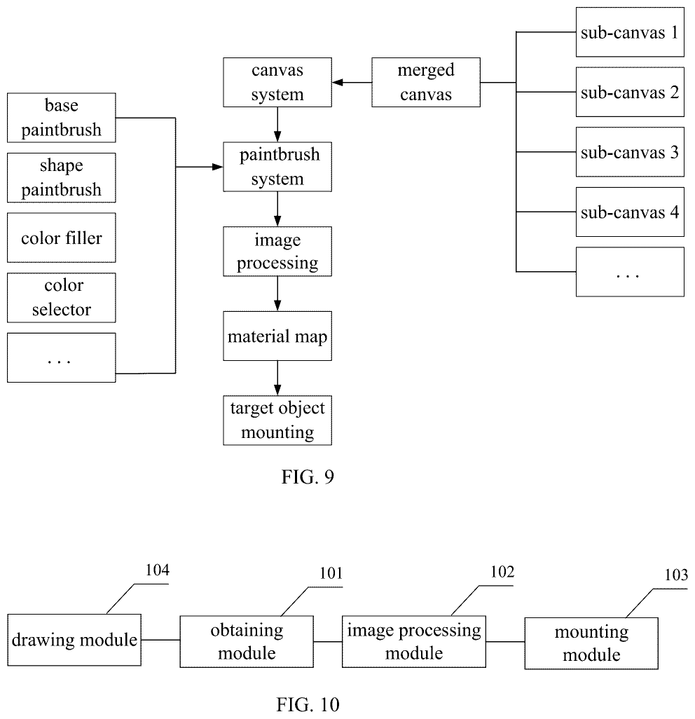

The image processing method according to the embodiment of the present disclosure is described in a specific application scenario. For example, as shown in FIG. 9, a flowchart of another image processing method according to the embodiment of the present disclosure, the embodiment of the present disclosure provides a canvas system supporting a plurality of sub-canvases, in which different drawing objects may correspond to different numbers of sub-canvases, and the plurality of sub-canvases may be merged into a larger canvas in real time at certain frame intervals, and also provides a paintbrush system in which a base paintbrush, a shape paintbrush, a color filler, a color selector, etc. may be supported, and a variety of drawing functions.

After drawing, a first image of the drawing object is obtained, and the first image is subjected to a magnified image process, and during the magnification, edge detection, interpolation, etc. is applied to each first pixel to obtain a target pixel value of the second pixel which is smoother and more accurate, and the resolution of the magnified second image is improved, so that the second image is subjected to a material map process as a map to obtain a material object, and during the application, the material object can be mounted to an object position of the target object.

Thus, in the embodiments of the present disclosure, a richer and low-cost canvas paintbrush system is realized, which is more suitable for a terminal device, and it is realized that a user can customize a painting object, which can apply the drawing object to different scenes, e.g., as a wearing effect for a character, and the like, satisfying the user's personalized needs, and improving the user's experience.

It will be appreciated by those skilled in the art that in the above described method of the specific implementation, the order in which the steps are written does not mean a strict order of execution to constitute any limitation on the implementation of the process, and the specific order of execution of the steps should be determined by the functionality and the possible underlying logic.

Based on the same inventive concept, the image processing apparatus corresponding to the image processing method is further provided in the embodiment of the present disclosure, since the principle of solving the problem by the apparatus in the embodiment of the present disclosure is similar to the above-described image processing method in the embodiment of the present disclosure, the implementation of the apparatus can be referred to the implementation of the method, and repeated contents are omitted.

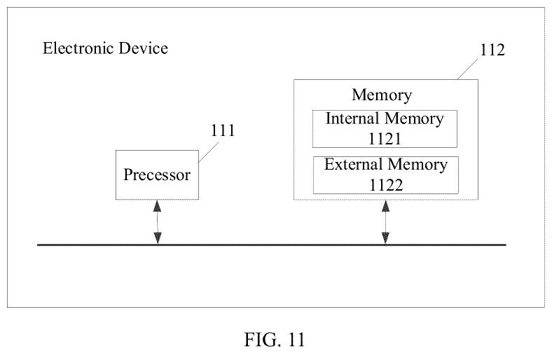

Referring to FIG. 10, a schematic diagram of an image processing apparatus provided for an embodiment of the present disclosure, the image processing apparatus comprises: an obtaining module 101, configured to obtain a first image drawn for a drawing object, wherein the drawing object is correspondingly split into a plurality of sub-objects, the first image is acquired by merging the plurality of sub-objects respectively drawn on a plurality of sub-canvases, and each of the plurality of sub-canvases is used for drawing one corresponding sub-object; an image processing module 102, configured to determine, for a first pixel in the first image, according to a target magnification, a pixel area block to which the first pixel is mapped in a second image, determining target pixel values of second pixels in the pixel area block, and obtaining the second image after magnification according to the target pixel values of the second pixels in the pixel area block; and a mounting module 103, configured to generate, according to the second image, a material object to which the drawing object corresponds, and mounting the material object to a corresponding position of a target object.

In one possible embodiment, the image processing apparatus further comprises a drawing module 104 which is configured to present the plurality of sub-canvases in response to a drawing object template selected for the drawing object, the plurality of sub-canvases corresponding to the drawing object template; and determine a sub-canvas currently operated in response to a switching operation for the plurality of the sub-canvases, receiving a drawing operation on the sub-canvas currently operated, and obtaining a target pattern drawn on the sub-canvas currently operated.

In one possible embodiment, while determining, for a first pixel in the first image, according to a target magnification, a pixel area block to which the first pixel is mapped in a second image, and determining target pixel values of second pixels in the pixel area block, the image processing module 102 is configured to: acquire, for the first pixel in the first image, peripheral pixels within a corresponding adjacent target range of the first pixel; determine, respectively for each target direction of the first pixel, whether an edge pixel exists in the each target direction in the first image for the first pixel according to pixel values of the peripheral pixels, and determine an initial pixel value of a second pixel corresponding to each target direction in the pixel area block according to a determination result of whether the edge pixel exists, until it is completed in all target directions, and determine the target pixel value of each of the second pixels in the pixel area block according to initial pixel values of each second pixel corresponding to all target directions, wherein the target direction is related to a distribution position of the second pixels in the pixel area block.

In one possible embodiment, when determining an initial pixel value of a second pixel corresponding to each target direction in the pixel area block according to a determination result of whether the edge pixel exists, the image processing module 102 is configured to: for each target direction, in response to an edge pixel in the target direction existing, determine a corresponding second pixel to the target direction in the pixel area block, determine an interpolated pixel value of the corresponding second pixel, and determine an initial pixel value of the corresponding second pixel according to a pixel value of the first pixel and the interpolated pixel value; and in response to an edge pixel in the target direction not existing, determine an initial pixel value of a corresponding second pixel to the target direction in the pixel area block according to the pixel value of the first pixel.

In one possible embodiment, when the determining an interpolated pixel value of the corresponding second pixel, the image processing module 102 is configured to: screen out first peripheral pixels associated with the target direction from the peripheral pixels; determine a pixel distance between the first pixel and each of the first peripheral pixels respectively, wherein the pixel distance represents a distance between a central point of the first pixel and a central point of each first peripheral pixel; and determine the interpolated pixel value of the corresponding second pixel according to a pixel value of a first peripheral pixel which has the smallest pixel distance to the first pixel.

In one possible embodiment, when determining the initial pixel value of the corresponding second pixel according to a pixel value of the first pixel and the interpolated pixel value, the image processing module 102 is configured to: screen out first peripheral pixels associated with the target direction from the peripheral pixels; determine a second peripheral pixel corresponding to each first peripheral pixel in a direction of a designated angle in the first image, wherein central points of each first peripheral pixel and the second peripheral pixel are connected by a straight line passing through the first pixel, to form the direction of the designated angle; judge whether pixel values of the first peripheral pixel and the corresponding second peripheral pixel are same; in response to the pixel values being the same corresponding to the direction of the designated angle, determine a corresponding second pixel in the pixel area block to the direction of the designated angle and determining the initial pixel value of the corresponding second pixel according to the pixel value of the first pixel, the interpolated pixel value, and the designated angle; in response to the pixel values being different in each direction of the designated angle, determine the initial pixel value of the corresponding second pixel according to an average value of the pixel value of the first pixel and the interpolated pixel value.

In one possible embodiment, when determining the target pixel value of each of the second pixels in the pixel area block according to initial pixel values of each second pixel corresponding to all target directions, the image processing module 102 is configured to: weighted average the initial pixel values of each of the second pixels corresponding to each target direction, and obtaining the target pixel value of each second pixel in the pixel area block.

The description of the process flow of the respective modules in the apparatus, and the interaction flow between the respective modules can refer to the related description in the above method embodiments, which will not be detailed here.

The embodiment of the present disclosure further provides an electronic device, as shown in FIG. 11, a structural schematic diagram of the electronic device provided by the embodiment of the present disclosure, comprising: a processor 111 and memory 112. The memory 112 stores machine-readable instructions executable by the processor 111, the processor 111 is configured to execute the machine-readable instructions stored in the memory 112, and when the machine-readable instructions are executed by the processor 111, when executed by the processor 110 is configured to perform the steps: acquiring a first image drawn for a drawing object, wherein the drawing object is correspondingly split into a plurality of sub-objects, the first image is acquired by merging the plurality of sub-objects respectively drawn on a plurality of sub-canvases, and each of the plurality of sub-canvases is used for drawing one corresponding sub-object; determining, for a first pixel in the first image, according to a target magnification, a pixel area block to which the first pixel is mapped in a second image, determining target pixel values of second pixels in the pixel area block, and obtaining the second image after magnification according to the target pixel values of the second pixels in the pixel area block; and generating, according to the second image, a material object to which the drawing object corresponds, and mounting the material object to a corresponding position of a target object.

In a possible embodiment, the processor 111 is further configured to: present the plurality of sub-canvases in response to a drawing object template selected for the drawing object, the plurality of sub-canvases corresponding to the drawing object template; and determine a sub-canvas currently operated in response to a switching operation for the plurality of the sub-canvases, receiving a drawing operation on the sub-canvas currently operated, and obtaining a target pattern drawn on the sub-canvas currently operated.

In one possible embodiment, while determining, for a first pixel in the first image, according to a target magnification, a pixel area block to which the first pixel is mapped in a second image, and determining target pixel values of second pixels in the pixel area block, the processor 111 is configured to: acquire, for the first pixel in the first image, peripheral pixels within a corresponding adjacent target range of the first pixel; determine, respectively for each target direction of the first pixel, whether an edge pixel exists in the each target direction in the first image for the first pixel according to pixel values of the peripheral pixels, and determine an initial pixel value of a second pixel corresponding to each target direction in the pixel area block according to a determination result of whether the edge pixel exists, until it is completed in all target directions, and determine the target pixel value of each of the second pixels in the pixel area block according to initial pixel values of each second pixel corresponding to all target directions, wherein the target direction is related to a distribution position of the second pixels in the pixel area block.

In one possible embodiment, when determining an initial pixel value of a second pixel corresponding to each target direction in the pixel area block according to a determination result of whether the edge pixel exists, the processor 111 is configured to: for each target direction, in response to an edge pixel in the target direction existing, determine a corresponding second pixel to the target direction in the pixel area block, determine an interpolated pixel value of the corresponding second pixel, and determine an initial pixel value of the corresponding second pixel according to a pixel value of the first pixel and the interpolated pixel value; and in response to an edge pixel in the target direction not existing, determine an initial pixel value of a corresponding second pixel to the target direction in the pixel area block according to the pixel value of the first pixel.

In one possible embodiment, when the determining an interpolated pixel value of the corresponding second pixel, the processor 111 is configured to: screen out first peripheral pixels associated with the target direction from the peripheral pixels; determine a pixel distance between the first pixel and each of the first peripheral pixels respectively, wherein the pixel distance represents a distance between a central point of the first pixel and a central point of each first peripheral pixel; and determine the interpolated pixel value of the corresponding second pixel according to a pixel value of a first peripheral pixel which has the smallest pixel distance to the first pixel.

In one possible embodiment, determining the initial pixel value of the corresponding second pixel according to a pixel value of the first pixel and the interpolated pixel value, the processor 111 is configured to: screen out first peripheral pixels associated with the target direction from the peripheral pixels; determine a second peripheral pixel corresponding to each first peripheral pixel in a direction of a designated angle in the first image, wherein central points of each first peripheral pixel and the second peripheral pixel are connected by a straight line passing through the first pixel, to form the direction of the designated angle; judge whether pixel values of the first peripheral pixel and the corresponding second peripheral pixel are same; in response to the pixel values being the same corresponding to the direction of the designated angle, determine a corresponding second pixel in the pixel area block to the direction of the designated angle and determining the initial pixel value of the corresponding second pixel according to the pixel value of the first pixel, the interpolated pixel value, and the designated angle; in response to the pixel values being different in each direction of a designated angle, determine the initial pixel value of the corresponding second pixel according to an average value of the pixel value of the first pixel and the interpolated pixel value.

In one possible embodiment, when determining the target pixel value of each of the second pixels in the pixel area block according to initial pixel values of each second pixel corresponding to all target directions, the processor 111 is configured to: weighted average the initial pixel values of each of the second pixels corresponding to each target direction, and obtaining the target pixel value of each second pixel in the pixel area block.

The storage 112 includes an internal memory 1121 and an external memory 1122; the memory 1121 is used for temporarily storing arithmetic data in the processor 111 and data exchanged with the external memory 1122 such as a hard disk, and the processor 111 is used for exchanging data with the external memory 1122 through the internal memory 1121.

The specific execution process of the above instructions may refer to the steps of the image processing method described in the embodiments of the present disclosure, which is not repeated here.

An embodiment of the present disclosure further provides a computer-readable storage medium storing a computer program, when the computer program is executed by the processor, the image processing method described in the above method embodiments is executed. The storage medium may be a volatile or non-volatile computer readable storage medium.

The embodiments of the present disclosure further provide a computer program product carrying program code including instructions for executing the steps of the image processing method described in the above method embodiments, which can be specifically referred to the above method embodiments, and are not described in detail herein.

The above-mentioned computer program product may be specifically implemented by means of hardware, software, or a combination thereof. In one alternative embodiment, the computer program product is embodied as a computer storage medium, and in another alternative embodiment, the computer program product is embodied as a software product, such as a Software Development Kit (SDK) or the like.

It can be clearly understood by those skilled in the art that, for convenience and conciseness of description, the specific working processes of the above-described systems and devices can be referred to the corresponding processes in the foregoing method embodiments, which are not repeated herein. In the several embodiments provided by the present disclosure, it is to be understood that the disclosed systems, devices, and methods may be implemented in other ways. The apparatus embodiments described above are merely illustrative, for example, the division of the units is merely in a manner of logical function, and other division manners may be actually implemented; for another example, multiple units or components may be combined or integrated into another system, or some features may be omitted or not performed. Further, the coupling or direct coupling or communication connection between each other shown or discussed may be an indirect coupling or communication connection through some communication interface, device or unit, which may be electrical, mechanical or otherwise.

The elements illustrated as separate elements may or may not be physically separate, and the elements shown as elements may or may not be physical elements, i.e. may be located at one place, or may be distributed over a plurality of network elements. Some or all of the elements may be selected according to actual needs to achieve the purpose of the present embodiment.

In addition, each functional unit in each embodiment of the present disclosure may be integrated in one processing unit, each unit may be physically present separately, and two or more units may be integrated in one unit.

The functions, if implemented in the form of a software functional unit and sold or used as a stand-alone product, may be stored in a processor-executable non-volatile computer-readable storage medium. Based on such an understanding, the technical solution of the present disclosure in essence or the part contributing to the prior art or the part of the technical solution may be embodied in the form of a software product stored in a storage medium, which includes a plurality of instructions for causing an electronic device (which may be a personal computer, a server, or a network device, etc.) to perform all or a part of the steps of the methods of the various embodiments of the present disclosure. The aforementioned storage media include various media that can store program codes, such as a compact disk, a removable hard disk, a read-only memory (ROM), a random access memory (RAM), a magnetic disk, or an optical disk.

Finally, it should be noted that the above-described embodiments are only specific implementation(s) of the present disclosure to illustrate the technical solutions of the present disclosure rather than to limit the scope of the present disclosure, and the scope of protection of the present disclosure is not limited thereto. Although the present disclosure has been described in detail with reference to the foregoing embodiments, those skilled in the art can understand that any person skilled in the art may modify the technical solutions described in the foregoing embodiments or may easily conceive of variations, or may substitute equivalents to some of the technical features thereof, within the technical scope of the present disclosure. These modifications, variations or replacements, which do not make the essence of the corresponding technical solutions depart from the spirit and scope of the technical solutions of the embodiments of the present disclosure, shall be covered within the protection scope of the present disclosure. Therefore, the protection scope of the present disclosure should be subject to the protection scope of the claims.

1. An image processing method, comprising:
acquiring a first image drawn for a drawing object, wherein the drawing object is correspondingly split into a plurality of sub-objects, the first image is acquired by merging the plurality of sub-objects respectively drawn on a plurality of sub-canvases, and each of the plurality of sub-canvases is used for drawing one corresponding sub-object;
determining, for a first pixel in the first image, according to a target magnification, a pixel area block to which the first pixel is mapped in a second image, determining target pixel values of second pixels in the pixel area block, and obtaining the second image after magnification according to the target pixel values of the second pixels in the pixel area block; and
generating, according to the second image, a material object to which the drawing object corresponds, and mounting the material object to a corresponding position of a target object.

2. The image processing method according to claim 1, further comprising:
presenting the plurality of sub-canvases in response to a drawing object template selected for the drawing object, the plurality of sub-canvases corresponding to the drawing object template; and
determining a sub-canvas currently operated in response to a switching operation for the plurality of the sub-canvases, receiving a drawing operation on the sub-canvas currently operated, and obtaining a target pattern drawn on the sub-canvas currently operated.

3. The image processing method according to claim 1, wherein the determining, for a first pixel in the first image, according to a target magnification, a pixel area block to which the first pixel is mapped in a second image, and determining target pixel values of second pixels in the pixel area block, comprises:
acquiring, for the first pixel in the first image, peripheral pixels within a corresponding adjacent target range of the first pixel;
determining, respectively for each target direction of the first pixel, whether an edge pixel exists in the each target direction in the first image for the first pixel according to pixel values of the peripheral pixels, and determining an initial pixel value of each second pixel corresponding to each target direction in the pixel area block according to a determination result of whether the edge pixel exists, and
determining the target pixel value of each of the second pixels in the pixel area block according to initial pixel values of each second pixel corresponding to all target directions, wherein the target direction is related to a distribution position of the second pixels in the pixel area block.

4. The image processing method according to claim 3, wherein the determining an initial pixel value of each second pixel corresponding to each target direction in the pixel area block according to a determination result of whether the edge pixel exists, comprises:
for each target direction, determining a corresponding second pixel to the target direction in the pixel area block, determining an interpolated pixel value of the corresponding second pixel, and determining an initial pixel value of the corresponding second pixel according to a pixel value of the first pixel and the interpolated pixel value in response to the edge pixel in the target direction existing; and
determining an initial pixel value of a corresponding second pixel to the target direction in the pixel area block according to the pixel value of the first pixel in response to an edge pixel in the target direction not existing.

5. The image processing method of claim 4, wherein the determining an interpolated pixel value of the corresponding second pixel comprises:
screening out first peripheral pixels associated with the target direction from the peripheral pixels;
determining a pixel distance between the first pixel and each of the first peripheral pixels respectively, wherein the pixel distance represents a distance between a central point of the first pixel and a central point of each first peripheral pixel; and
determining the interpolated pixel value of the corresponding second pixel according to a pixel value of a first peripheral pixel which has a smallest pixel distance to the first pixel.

6. The image processing method according to claim 5, wherein the determining an initial pixel value of the corresponding second pixel according to a pixel value of the first pixel and the interpolated pixel value comprises:
determining a second peripheral pixel corresponding to each of the first peripheral pixels in a direction of a designated angle in the first image, wherein central points of each first peripheral pixel and the corresponding second peripheral pixel are connected by a straight line passing through the first pixel, to form the direction of the designated angle;
judging whether pixel values of the first peripheral pixel and the corresponding second peripheral pixel are same;
in response to the pixel values being the same corresponding to a direction of a designated angle, determining a corresponding second pixel in the pixel area block to the direction of the designated angle and determining the initial pixel value of the corresponding second pixel according to the pixel value of the first pixel, the interpolated pixel value, and the designated angle; and
in response to the pixel values being different in each direction of a designated angle, determining the initial pixel value of the corresponding second pixel according to an average value of the pixel value of the first pixel and the interpolated pixel value.

7. The image processing method according to claim 6, wherein the determining the initial pixel value of the corresponding second pixel according to the pixel value of the first pixel, the interpolated pixel value, and the designated angle, comprises:
determining the initial pixel value of the corresponding second pixel to be a weighted average value of the pixel value of the first pixel and the interpolated pixel value, wherein weights of the pixel value of the first pixel and the interpolated pixel value are determined by the designated angle.

8. The image processing method according to claim 6, wherein the determining the initial pixel value of the corresponding second pixel according to an average value of the pixel value of the first pixel and the interpolated pixel value comprises:
determining the initial pixel value of the corresponding second pixel to be the average value of the pixel value of the first pixel and the interpolated pixel value.

9. The image processing method according to claim 4, wherein the determining the target pixel value of each of the second pixels in the pixel area block according to initial pixel values of each second pixel corresponding to all target directions, comprises:
for each of the second pixels, determining the initial pixel values of each second pixel corresponding to all target directions from the determined initial pixel values of second pixels corresponding to all target directions, and
weighted averaging the determined initial pixel values of each second pixel corresponding to all target directions, and obtaining the target pixel value of each second pixel in the pixel area block.

10. The image processing method according to claim 4, wherein the determining the initial pixel value of the corresponding second pixel according to a pixel value of the first pixel and the interpolated pixel value comprises:
screening out first peripheral pixels associated with the target direction from the peripheral pixels;
determining a second peripheral pixel corresponding to each first peripheral pixel in a direction of a designated angle in the first image, wherein central points of each first peripheral pixel and the second peripheral pixel are connected by a straight line passing through the first pixel, to form the direction of the designated angle;
judging whether pixel values of the first peripheral pixel and the corresponding second peripheral pixel are same;
in response to the pixel values being the same corresponding to a direction of a designated angle, determining a corresponding second pixel in the pixel area block to the direction of the designated angle and determining the initial pixel value of the corresponding second pixel according to the pixel value of the first pixel, the interpolated pixel value, and the designated angle;
in response to the pixel values being different in each direction of a designated angle, determining the initial pixel value of the corresponding second pixel according to an average value of the pixel value of the first pixel and the interpolated pixel value.

11. The image processing method according to claim 10, wherein the determining the initial pixel value of the corresponding second pixel according to the pixel value of the first pixel, the interpolated pixel value, and the designated angle, comprises:
determining the initial pixel value of the corresponding second pixel to be a weighted average value of the pixel value of the first pixel and the interpolated pixel value, wherein weights of the pixel value of the first pixel and the interpolated pixel value are determined by the designated angle.

12. The image processing method according to claim 10, wherein the determining the initial pixel value of the corresponding second pixel according to an average value of the pixel value of the first pixel and the interpolated pixel value comprises:
determining the initial pixel value of the corresponding second pixel to be the average value of the pixel value of the first pixel and the interpolated pixel value.

13. The image processing method according to claim 4, wherein the determining an initial pixel value of a corresponding second pixel to the target direction in the pixel area block according to the pixel value of the first pixel comprises:
determining the pixel value of the first pixel to be the initial pixel value of the corresponding second pixel.

14. The image processing method according to claim 3, wherein the determining the target pixel value of each of the second pixels in the pixel area block according to initial pixel values of each second pixel corresponding to all target directions, comprises:
weighted averaging the initial pixel values of each of the second pixels corresponding to each target direction, and obtaining the target pixel value of each second pixel in the pixel area block.

15. An electronic device, comprising:
at least a processor and a memory storing machine-readable instructions executable by the processor,
wherein the processor is configured to execute the machine-readable instructions stored in the memory, and when the machine-readable instructions are executed by the processor, an image processing method is implemented by the processor and the image processing method comprises:
acquiring a first image drawn for a drawing object, wherein the drawing object is correspondingly split into a plurality of sub-objects, the first image is acquired by merging the plurality of sub-objects respectively drawn on a plurality of sub-canvases, and each of the plurality of sub-canvases is used for drawing one corresponding sub-object;
determining, for a first pixel in the first image, according to a target magnification, a pixel area block to which the first pixel is mapped in a second image, determining target pixel values of second pixels in the pixel area block, and obtaining the second image after magnification according to the target pixel values of the second pixels in the pixel area block; and
generating, according to the second image, a material object to which the drawing object corresponds, and mounting the material object to a corresponding position of a target object.

16. The electronic device according to claim 15, wherein the image processing method further comprises:
presenting the plurality of sub-canvases in response to a drawing object template selected for the drawing object, the plurality of sub-canvases corresponding to the drawing object template; and
determining a sub-canvas currently operated in response to a switching operation for the plurality of the sub-canvases, receiving a drawing operation on the sub-canvas currently operated, and obtaining a target pattern drawn on the sub-canvas currently operated.

17. The electronic device according to claim 15, wherein the determining, for a first pixel in the first image, according to a target magnification, a pixel area block to which the first pixel is mapped in a second image, and determining target pixel values of second pixels in the pixel area block, comprises:
acquiring, for the first pixel in the first image, peripheral pixels within a corresponding adjacent target range of the first pixel;
determining, respectively for each target direction of the first pixel, whether an edge pixel exists in the each target direction in the first image for the first pixel according to pixel values of the peripheral pixels, and determining an initial pixel value of each second pixel corresponding to each target direction in the pixel area block according to a determination result of whether the edge pixel exists, and
determining the target pixel value of each of the second pixels in the pixel area block according to initial pixel values of each second pixel corresponding to all target directions, wherein the target direction is related to a distribution position of the second pixels in the pixel area block.

18. A non-transitory computer-readable storage medium storing a computer program, wherein when the computer program is executed by at least a processor, an image processing method is implemented and the image processing method comprises:
acquiring a first image drawn for a drawing object, wherein the drawing object is correspondingly split into a plurality of sub-objects, the first image is acquired by merging the plurality of sub-objects respectively drawn on a plurality of sub-canvases, and each of the plurality of sub-canvases is used for drawing one corresponding sub-object;
determining, for a first pixel in the first image, according to a target magnification, a pixel area block to which the first pixel is mapped in a second image, determining target pixel values of second pixels in the pixel area block, and obtaining the second image after magnification according to the target pixel values of the second pixels in the pixel area block; and
generating, according to the second image, a material object to which the drawing object corresponds, and mounting the material object to a corresponding position of a target object.

19. The non-transitory computer-readable storage medium according to claim 18, wherein the image processing method further comprises:
presenting the plurality of sub-canvases in response to a drawing object template selected for the drawing object, the plurality of sub-canvases corresponding to the drawing object template; and
determining a sub-canvas currently operated in response to a switching operation for the plurality of the sub-canvases, receiving a drawing operation on the sub-canvas currently operated, and obtaining a target pattern drawn on the sub-canvas currently operated.

20. The non-transitory computer-readable storage medium according to claim 18, wherein the determining, for a first pixel in the first image, according to a target magnification, a pixel area block to which the first pixel is mapped in a second image, and determining target pixel values of second pixels in the pixel area block, comprises:
acquiring, for the first pixel in the first image, peripheral pixels within a corresponding adjacent target range of the first pixel;
determining, respectively for each target direction of the first pixel, whether an edge pixel exists in the each target direction in the first image for the first pixel according to pixel values of the peripheral pixels, and determining an initial pixel value of each second pixel corresponding to each target direction in the pixel area block according to a determination result of whether the edge pixel exists, and
determining the target pixel value of each of the second pixels in the pixel area block according to initial pixel values of each second pixel corresponding to all target directions, wherein the target direction is related to a distribution position of the second pixels in the pixel area block.
